(19) United States
(12) Patent Application Publication
(10) Pub. No.: US 2018/0111337 A1
(43) Pub. Date: Apr. 26, 2018

(54) WATER DISPERSIBLE POLYMER COMPOSITION FOR USE IN 3D PRINTER

(71) Applicant: Stratasys, Inc., Eden Prairie, MN (US)

(72) Inventors: Benjamin A. Demuth, River Falls, WI (US); Adam R. Pawloski, Lake Elmo, MN (US)

(21) Appl. No.: 15/333,870

(22) Filed: Oct. 25, 2016

(51) Int. Cl. B29C 67/00; B33Y 10/00; B33Y 70/00; C08L 29/04; C09D 129/04

(52) U.S. Cl. CPC B29C 67/0092; B29C 67/0055; B33Y 10/00; B29K 2077/00; C08L 29/04; C09D 129/04; B33Y 70/00

(57) ABSTRACT

A polymeric composition is used as a consumable material in 3D printer. The composition includes a water soluble polymer or polymer blend that is at least about 50 wt % of the total weight of the composition. The composition includes a rheologic modifier that is at least about 1 wt % of the total weight of the polymeric composition. The composition includes a filler that is at least about 10 wt % of the total weight of the polymeric composition. At least 90 wt % of the individual ingredient compositions before mixing are water soluble.

### BACKGROUND

The present disclosure relates to additive manufacturing systems for printing three-dimensional (3D) parts and support structures. In particular, the present disclosure relates to a water soluble material for use in 3D printers, and methods of printing 3D parts.

Additive manufacturing, also called 3D printing, is generally a process in which a three-dimensional (3D) object is built by adding material to form a 3D part rather than subtracting material as in traditional machining. One basic operation of an additive manufacturing system consists of slicing a three-dimensional computer model into thin cross sections, translating the result into two-dimensional position data, and feeding the data to control equipment which manufacture a three-dimensional structure in an additive build style. Additive manufacturing entails many different approaches to the method of fabrication, including fused deposition modeling, ink jetting, selective laser sintering, powder/binder jetting, electron-beam melting, electrophotographic imaging, and stereolithographic processes. Using one or more additive manufacturing techniques, a three-dimensional solid object of virtually any shape can be printed from a digital model of the object by an additive manufacturing system, commonly referred to as 3D printer.

In a fused deposition modeling additive manufacturing system, a printed part may be printed from a digital representation of the printed part in an additive build style by extruding a flowable part material along toolpaths. The part material is extruded through an extrusion tip carried by a print head of the system, and is deposited as a sequence of roads onto a substrate. The extruded part material fuses to previously deposited part material, and solidifies upon a drop in temperature. In a typical system where the material is deposited in planar layers, the position of the print head relative to the substrate is incremented along an axis (perpendicular to the build plane) after each layer is formed, and the process is then repeated to form a printed part resembling the digital representation.

In fabricating printed parts by depositing layers of a part material, supporting layers or structures are typically built underneath overhanging portions or in cavities of printed parts under construction, which are not supported by the part material itself. A support structure may be built utilizing the same deposition techniques by which the part material is deposited. A host computer generates additional geometry acting as a support structure for the overhanging or free-space segments of the printed part being formed. Support material is then deposited from a second nozzle pursuant to the generated geometry during the printing process. The support material adheres to the part material during fabrication, and is removable from the completed printed part when the printing process is complete.

### SUMMARY

An aspect of the present disclosure relates to a polymeric composition that is used as a consumable material in 3D printer. The composition includes a water soluble polymer or polymer blend that is at least about 50 wt % of the total weight of the composition. The composition includes a rheologic modifier that is at least about 1 wt % of the total weight of the polymeric composition. The composition includes a filler that is at least about 10 wt % of the total weight of the polymeric composition. At least 90 wt % of the individual ingredient compositions before mixing are water soluble.

Another aspect of the present disclosure relates to a water soluble polymeric composition for use as a consumable material in a 3D printer. The composition includes a water soluble polymer matrix comprising semi-crystalline polyvinyl alcohol and water soluble polyamide wherein the water soluble polymer matrix comprises at least about 50 percent of a total weight of the composition. The composition also includes a filler comprising about 10 wt % and about 50 wt % of the total weight of the composition.

Another aspect of the present disclosure relates to a method for printing a three-dimensional part with an additive manufacturing system. The method includes providing a support material comprising a water soluble polymer matrix comprising semi-crystalline polyvinyl alcohol and water soluble polyamide wherein the water soluble polymer matrix comprises at least about 50 percent of a total weight of the composition and a filler comprising about 10 wt % and about 50 wt % of the total weight of the composition, wherein the support material is disintegrable in an aqueous solution and provided in a media form suitable for the additive manufacturing system. The method includes processing the support material in the additive manufacturing system with a model material.

### Definitions

Unless otherwise specified, the following terms as used herein have the meanings provided below:

The term “polymer” refers to a polymerized molecule having one or more monomer species, and includes homopolymers and copolymers. The term “copolymer” refers to a polymer having two or more monomer species, and includes terpolymers (i.e., copolymers having three monomer species).

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the inventive scope of the present disclosure.

Reference to “a” chemical compound refers to one or more molecules of the chemical compound, rather than being limited to a single molecule of the chemical compound. Furthermore, the one or more molecules may or may not be identical, so long as they fall under the category of the chemical compound. Thus, for example, “a” polyester is interpreted to include one or more polymer molecules of the polyester, where the polymer molecules may or may not be identical (e.g., different molecular weights and/or isomers).

The terms “at least one” and “one or more of” an element are used interchangeably, and have the same meaning that includes a single element and a plurality of the elements, and may also be represented by the suffix “(s)” at the end of the element. For example, “at least one polyester”, “one or more polyesters”, and “polyester(s)” may be used interchangeably and have the same meaning.

The terms “about”, approximately and “substantially” are used herein with respect to measurable values and ranges due to expected variations known to those skilled in the art (e.g., limitations and variabilities in measurements).

The term “providing”, such as for “providing a support material”, when recited in the claims, is not intended to require any particular delivery or receipt of the provided item. Rather, the term “providing” is merely used to recite items that will be referred to in subsequent elements of the claim(s), for purposes of clarity and ease of readability.

Unless otherwise specified, temperatures referred to herein are based on atmospheric pressure (i.e. one atmosphere).

“Water soluble” as referred to herein can be used interchangeably with “disintegrable” and “dissolvable” and relates to materials that disintegrate in an aqueous solution or a dispersion that does not contain any other component (such as a base e.g. sodium hydroxide or an acid) which may aid in the disintegration or dissolution of the material. In other words, it is the water that dissolves or disintegrates the material. Upon disintegration, the support material can break apart into smaller pieces and/or particles of polymer in the aqueous solution or dispersion. Some or all of the support material may also dissolve into the aqueous solution or dispersion upon disintegration.

“Low temperature build environment” as referred to herein relates to build environments from ambient conditions to about a 95° C. or less in additive manufacturing systems.

“Thermally stable” as referred to herein relates to the support material having a heat deflection temperature sometimes referred to as heat distortion temperature (HDT) compatible with the desired build environment such that they do not exceed their thermal-degradation kinetics thresholds (TDKT).

### BRIEF DESCRIPTION OF THE DRAWINGS

FIG. 1 is a front view of an extrusion-based additive manufacturing system configured to print printed parts and support structures, where the support structures are printed from a support material of the present disclosure.

FIG. 2 is a front view of a print head of the extrusion-based additive manufacturing system.

FIG. 3 is an expanded sectional view of a drive mechanism, a liquefier assembly, and a nozzle of the print head for use in the extrusion-based additive manufacturing system.

### DETAILED DESCRIPTION

The present disclosure is directed to a water soluble material that is typically utilized as support material for a part being built in a 3D printer utilizing a low temperature build environment. In some applications, the material can be utilized to produce a part material that is a model or core to build a part, such as a carbon fiber part. Exemplary 3D printers that utilize low temperature build environment to print 3D parts in a layer by layer manner using a fused deposition modeling process include the Stratasys Fortus 400mc 3D printer and the Makerbot Replicator 2 and 2X printers.

Water soluble polymers are generally not suited for FDM processes because of temperature, toughness and rheological limitations. Water soluble polymers tend to be brittle and when formed into a filament have a tendency to break while being moved through a filament path in a typical FDM printer. The water soluble polymers can also thermally degrade in build environments at elevated temperatures, such as temperatures between about 300° C. and about 500° C. Additionally, the water soluble polymers tend to be viscous when melted which make printing a 3D part with an extrusion based 3D printer difficult.

The compositions described herein have properties which make the use of water soluble, low temperature, support materials in FDM systems feasible. The support material of this disclosure can be removed significantly faster than traditional alkaline soluble support materials. The composition described herein is also capable of withstanding low temperature build environments through physical reinforcement, resulting in a heat deflection temperature sufficient to be utilized with a material utilized to print the 3D part. above that of the build resin.

The support material of the present disclosure can be utilized as a sacrificial material for an associated part material. A support material can be desirable where overhanging features are required, where significant angular slopes exist in the printed items and where it is essential to also preserve delicate features in the printed item, such as small orifices or controlled pore structures, and in some situations, to laterally encase the printed item.

Once the item has been printed, the support structure or the support material is removed to reveal the completed printed item without damaging any of the critical or delicate geometrical features of the printed item. To accomplish this removal, the disclosed support material is water soluble or dispersable, allowing the support structure to be at least partially and typically completely removed from the printed item. The water can be tap water or any aqueous solution with a pH between 5 and 9, which is readily available and removes environmental and safety issues associated with alkaline baths.

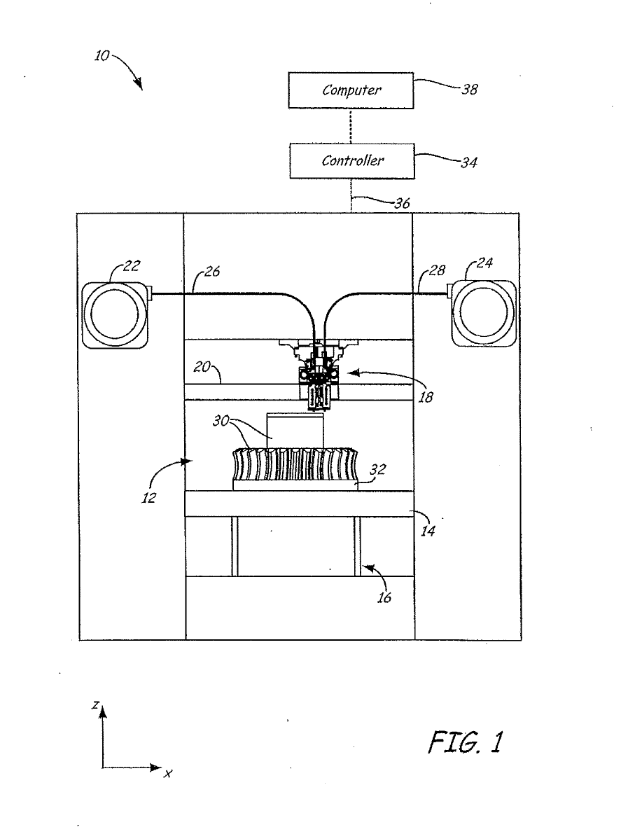

The support material of the present disclosure may be configured for use with several different additive manufacturing techniques, such as extrusion-based additive manufacturing systems, high-speed sintering systems, selective laser sintering systems, electrophotography-based additive manufacturing systems, and the like. Further, the use of the disclosed material is not limited to additive manufacturing. As shown in FIG. 1, 3D printer 10 is an example of an extrusion-based additive manufacturing system for printing or otherwise building 3D parts and support structures using a layer-based, additive manufacturing technique, where the support structures may be printed from the support material of the present disclosure. Suitable extrusion-based additive manufacturing systems for 3D printer 10 include fused deposition modeling systems developed by Stratasys, Inc., Eden Prairie, Minn. under the trademark “FDM”.

In the illustrated embodiment, 3D printer 10 includes chamber 12, platen 14, platen gantry 16, print head 18, head gantry 20, and consumable assemblies 22 and 24. Chamber 12 is an enclosed environment that contains platen 14 for printing printed parts and support structures. Chamber 12 may be heated (e.g., with circulating heated air) to reduce the rate at which the part and support materials solidify after being extruded and deposited.

Alternatively, the heating may be localized rather than in an entire chamber 12. For example, the deposition region may be heated in a localized manner. Example techniques for locally-heating a deposition region include heating platen 14 and/or with directing heat air jets towards platen 14 and/or the printed parts/support structures being printed). The heating anneals the printed layers of the printed parts (and support structures) to partially relieve the residual stresses, thereby reducing curling of the printed parts and support structures.

In some instances, chamber is not heated. In other instances, an out of oven 3D printer can be utilized where the 3D printer does not have a chamber.

Platen 14 is a platform on which printed parts and support structures are printed in a layer-by-layer manner. In some embodiments, platen 14 may also include a flexible polymeric film or liner on which the printed parts and support structures are printed. In the shown example, print head 18 is a dual-tip extrusion head configured to receive consumable filaments from consumable assemblies 22 and 24 (e.g., via guide tubes 26 and 28) for printing printed part 30 and support structure 32 on platen 14. Consumable assembly 22 may contain a supply of a part material for printing printed part 30 from the part material. Consumable assembly 24 may contain a supply of a support material of the present disclosure for printing support structure 32 from the given support material.

Platen 14 is supported by platen gantry 16, which is a gantry assembly configured to move platen 14 along (or substantially along) a vertical z-axis. Correspondingly, print head 18 is supported by head gantry 20, which is a gantry assembly configured to move print head 18 in (or substantially in) a horizontal x-y plane above chamber 12.

In an alternative embodiment, platen 14 may be configured to move in the horizontal x-y plane within chamber 12, and print head 18 may be configured to move along the z-axis. Other similar arrangements may also be used such that one or both of platen 14 and print head 18 are moveable relative to each other. Platen 14 and print head 18 may also be oriented along different axes. For example, platen 14 may be oriented vertically and print head 18 may print printed part 30 and support structure 32 along the x-axis or the y-axis.

3D printer 10 also includes controller 34, which is one or more control circuits configured to monitor and operate the components of 3D printer 10. For example, one or more of the control functions performed by controller 34 can be implemented in hardware, software, firmware, and the like, or a combination thereof. Controller 34 may communicate over communication line 36 with chamber 12 (e.g., with a heating unit for chamber 12), print head 18, and various sensors, calibration devices, display devices, and/or user input devices.

3D printer 10 and/or controller 34 may also communicate with computer 38, which is one or more computer-based systems that communicates with 3D printer 10 and/or controller 34, and may be separate from 3D printer, or alternatively may be an internal component of 3D printer 10. Computer 38 includes computer-based hardware, such as data storage devices, processors, memory modules, and the like for generating and storing tool path and related printing instructions. Computer 38 may transmit these instructions to 3D printer 10 (e.g., to controller 34) to perform printing operations.

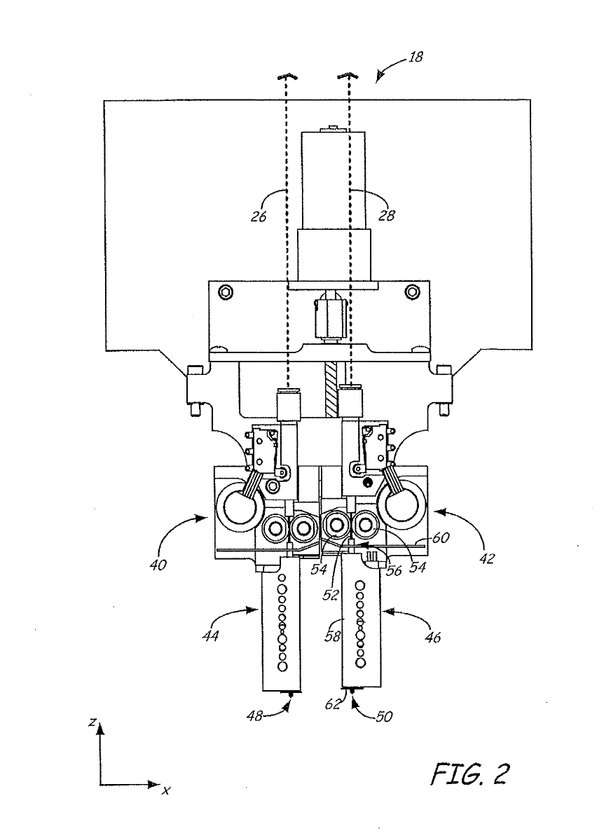

FIG. 2 illustrates a suitable device for print head 18, as described in Leavitt, U.S. Pat. No. 7,625,200. Additional examples of suitable devices for print head 18, and the connections between print head 18 and head gantry 20 include those disclosed in Crump et al., U.S. Pat. No. 5,503,785; Swanson et al., U.S. Pat. No. 6,004,124; LaBossiere, et al., U.S. Pat. Nos. 7,384,255 and 7,604,470; Leavitt, U.S. Pat. No. 7,625,200; Batchelder et al., U.S. Pat. No. 7,896,209; and Comb et al., U.S. Pat. No. 8,153,182. In additional embodiments, in which print head 18 is an interchangeable, single-nozzle print head, examples of suitable devices for each print head 18, and the connections between print head 18 and head gantry 20 include those disclosed in Swanson et al., U.S. Pat. Nos. 8,419,996 and 8,647,102.

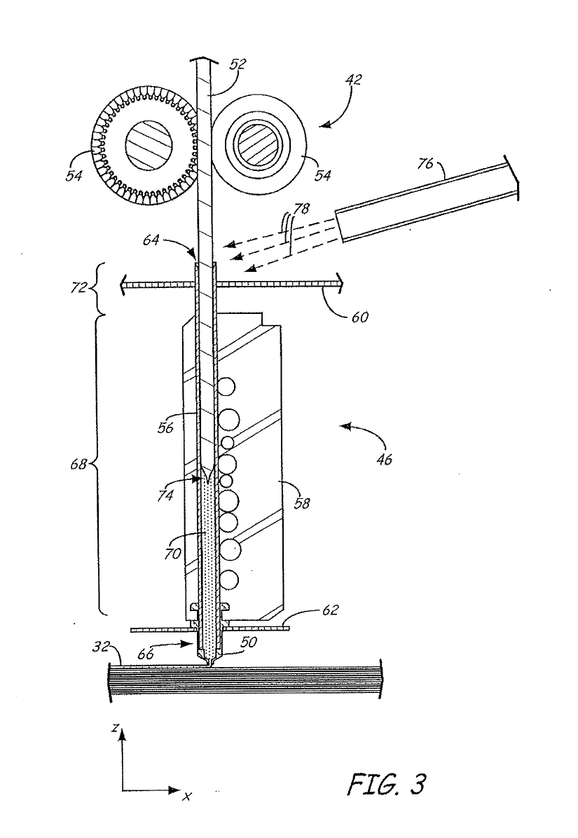

In the shown dual-tip embodiment, print head 18 includes two drive mechanisms 40 and 42, two liquefier assemblies 44 and 46, and two nozzles 48 and 50, where drive mechanism 40, liquefier assembly 44, and nozzle 48 are for receiving and extruding the part material, and drive mechanism 42, liquefier assembly 46, and nozzle 50 are for receiving and extruding the support material of the present disclosure. In this embodiment, the part material and the support material each preferably have a filament geometry for use with print head 18. For example, as shown in FIGS. 2 and 3, the support material may be provided as filament 52.

During operation, controller 34 may direct wheels 54 of drive mechanism 42 to selectively draw successive segments filament 52 (of the support material) from consumable assembly 24 (via guide tube 28), and feed filament 52 to liquefier assembly 46. Liquefier assembly 46 may include liquefier tube 56, thermal block 58, heat shield 60, and tip shield 62, where liquefier tube 56 includes inlet end 64 for receiving the fed filament 52. Nozzle 50 and tip shield 62 are accordingly secured to outlet end 66 of liquefier tube 56, and liquefier tube 56 extends through thermal block 58 and heat shield 60.

While liquefier assembly 46 is in its active state, thermal block 58 heats liquefier tube 56 to define heating zone 68. The heating of liquefier tube 56 at heating zone 68 melts the support material of filament 52 in liquefier tube 56 to form melt 70. Preferred liquefier temperatures for the support material range will vary depending on the particular polymer composition of the support material, and are preferably above the melt processing temperature of the support material, while also allowing the support material to remain below its TDKT for the expected residence time in liquefier tube 56.

The upper region of liquefier tube 56 above heating zone 68, referred to as transition zone 72, is preferably not directly heated by thermal block 58. This generates a thermal gradient or profile along the longitudinal length of liquefier tube 56.

The molten portion of the support material (i.e., melt 70) forms meniscus 74 around the un-melted portion of filament 52. During an extrusion of melt 70 through nozzle 50, the downward movement of filament 52 functions as a viscosity pump to extrude the support material of melt 70 out of nozzle 50 as extruded roads to print support structure 32 in a layer-by-layer manner in coordination with the printing of printed part 30. While thermal block 58 heats liquefier tube 56 at heating zone 68, cooling air may also be blown through an optional manifold 76 toward inlet end 64 of liquefier tube 56, as depicted by arrows 78. Heat shield 60 assists in directing the air flow toward inlet end 64. The cooling air reduces the temperature of liquefier tube 56 at inlet end 64, which prevents filament 52 from softening or melting at transition zone 72.

In some embodiments, controller 34 may servo or swap liquefier assemblies 44 and 46 between opposing active and stand-by states. For example, while liquefier assembly 46 is servoed to its active state for extruding the support material to print a layer of support structure 32, liquefier assembly 44 is switched to a stand-by state to prevent the part material from being extruded while liquefier assembly 46 is being used. After a given layer of the support material is completed, controller 34 then servoes liquefier assembly 46 to its stand-by state, and switches liquefier assembly 44 to its active state for extruding the part material to print a layer of printed part 30. This servo process may be repeated for each printed layer until printed part 30 and support structure 32 are completed.

While liquefier assembly 44 is in its active state for printing printed part 30 from a part material filament, drive mechanism 40, liquefier assembly 44, and nozzle 48 (each shown in FIG. 2) may operate in the same manner as drive mechanism 42, liquefier assembly 46, and nozzle 50 for extruding the part material. In particular, drive mechanism 40 may draw successive segments of the part material filament from consumable assembly 22 (via guide tube 26), and feed the part material filament to liquefier assembly 44. Liquefier assembly 44 thermally melts the successive portions of the received part material filament such that it becomes a molten part material. The molten part material may then be extruded and deposited from nozzle 48 as a series of roads onto platen 14 for printing printed part 30 in a layer-by-layer manner in coordination with the printing of support structure 32.

After the print operation is complete, the resulting printed part 30 and support structure 32 may be removed from chamber 12. Support structure 32 may then be sacrificially removed from printed part 30, such as by dissolution in an aqueous solution, aqueous dispersion or tap water. Examples of suitable removal units for dissolving or disintegrating support structure 32 include those disclosed in Swanson et al., U.S. Pat. No. 8,459,280. Using support removal methodology, support structure 32 may at least partially disintegrate in the aqueous solution or dispersion, separating it from printed part 30 in a hands-free manner.

The general composition of the support material of this disclosure includes a composition comprising a water soluble polymer or polymer blend to serve as matrix, a filler, and an additive to control rheology. In one embodiment, the polymer is a semi-crystalline semi-crystalline polyvinyl alcohol, in another embodiment the polymer is a water soluble polyamide, and yet in another embodiment, the polymer is a blend of a semi-crystalline semi-crystalline polyvinyl alcohol and a polyamide. Water soluble polyesters are also suitable, alone or in combination with semi-crystalline polyvinyl alcohol and/or polyamide as described herein.

In some embodiments, the water soluble polymer matrix may constitute at least about 50 wt % of the total weight of composition. In other embodiments, the water soluble polymer matrix is in the range between about 50 wt % and about 95 wt % of the total weight of the composition. In other embodiments, the water soluble polymer matrix is in the range between about 50 wt % and about 90 wt % of the total weight of the composition. In other embodiments, the water soluble polymer matrix is in the range between about 50 wt % and about wt % of the total weight of the composition.

In some embodiments, the polymer matrix can include a blend of semi-crystalline polyvinyl alcohol in a range of 50 wt % and about 90 wt % and water soluble polyamide in the range of about 10 wt % to about 30 wt % based upon the total weight of the composition. In other embodiments, the polymer matrix can include a blend of semi-crystalline polyvinyl alcohol in a range of 60 wt % and about 80 wt % and water soluble polyamide in the range of about 15 wt % to about 25 wt % based upon the total weight of the composition. In yet other embodiments, the polymer matrix can include a blend of semi-crystalline polyvinyl alcohol in a range of 65 wt % and about 75 wt % and water soluble polyamide in the range of about 17 wt % to about 23 wt % based upon the total weight of the composition.

In other embodiments, the polymer matrix includes a larger wt % of water soluble polyamide relative to the wt % of the semi-crystalline polyvinyl alcohol. In some embodiments, the polymer matrix can include a blend of semi-crystalline polyvinyl alcohol in a range of 10 wt % and about 50 wt % and water soluble polyamide in the range of about 40 wt % to about 85 wt % based upon the total weight of the composition. In other embodiments, the polymer matrix can include a blend of semi-crystalline polyvinyl alcohol in a range of 15 wt % and about 45 wt % and water soluble polyamide in the range of about 50 wt % to about 80 wt % based upon the total weight of the composition. In yet other embodiments, the polymer matrix can include a blend of semi-crystalline polyvinyl alcohol in a range of 15 wt % and about 25 wt % and water soluble polyamide in the range of about 50 wt % to about 75 wt % based upon the total weight of the composition.

In some instances, the filler is water soluble dispersible and serves as a physical reinforcement at elevated temperatures, such as when the material is melted and extruded. One suitable filler is sodium chloride. Another suitable water soluble fillers include calcium carbonate and a suitable water insoluble filler that can be utilized is magnesium silicate.

In some embodiments, one or more fillers can be added to the composition in the range of between about 10 wt % and about 50 wt % based upon the total weight of the composition. In other embodiments, one or more fillers can be added to the composition in the range of between about 20 wt % and about 40 wt %.

In some embodiments, a rheologic modifier can optionally be added to the composition to enhance the ability to extrude the water soluble material. The rheological additive can be water soluble polyamide, polyethylene glycol, polypropylene glycol, poly(2-ethyl-2-oxazoline) or combinations thereof. When water soluble polyamide is utilized in the polymer matrix an addition rheologic modifier may not be necessary. If the rheologic modifier is included in the composition, the rheologic modifier can be in the range of between about 1 wt % and about 30 wt % in some embodiments. In other embodiments, the rheologic modifier can be in the range of between about 5 wt % and about 20 wt %.

In some embodiments 100 wt % of the composition is water soluble. In other embodiments, between about 95 wt % and 100 wt % of the individual ingredient compositions before mixing are water soluble. In other embodiments, between about 90 wt % and 100 wt % of the individual ingredient compositions are water soluble.

The support material of this disclosure is suitable for use in a 3D printer as a filament or a powder. The filament can have any suitable cross sectional configuration including a substantially circular cross section and a configuration having an aspect ratio greater than or equal to 2:1. The material can also be provided in a powder form and utilized with a viscosity pump based screw extruder. Finally, the material can be formulated with a charge control agent and utilized in an electro-photographic based additive manufacturing system.

The present disclosure is more particularly described in the following example that is intended as illustrations only, since numerous modifications and variations within the scope of the present disclosure will be apparent to those skilled in the art.

### Example

A composition of this disclosure was produced by initially blending a mixture of Poval semi-crystalline polyvinyl alcohol (70% by wt) which is water soluble and produced by Japan Vam & Poval Co, LTD of Japan, AQ nylon (20% by wt) which is water soluble and produced by Toray Industries, Inc. of Japan and sodium chloride (10% by wt). The mixture was blended and then fed into a 27 mm co-rotating 37:1 L/D twin screw extruder operating at about 300 RPM. The approximate temperature profile across the zones of the extruder during blend extrusion was as follows from zones 1 through 8: zone 1-160° C., zone 2-180° C., zone 3-200° C., zone 4-200° C., zone 5-180° C., zone 6-180° C., zone 7-180° C., and a die temperature of approximately 180° C. The blend was then extruded through a 3 hole die onto a belt, air cooled, and the strands then pelletized.

To produce a filament extrusion suitable for a FDM system, the pellets produced as described above were fed into a 1.25 inch single screw 2.5:1 L/D extruder running at about 20 RPM. The approximate temperature profile along the extruder barrel during this extrusion was as follows from zones 1 to zone 3: zone 1-150° C., zone 2-165° C., and a die temperature of at least 160° C. The composition was then extruded through a monofilament die, through an air ring and pulled onto an air frame. The filament was wound through the airframe and fed through a laser micrometer linked to a pulling system. The laser micrometer and air frame pattern were set such as to create a consistent round filament. The filament was then wound onto a spool for future use in a FDM system.

Although the present disclosure has been described with reference to preferred embodiments, workers skilled in the art will recognize that changes may be made in form and detail without departing from the spirit and scope of the disclosure.

1. A water soluble polymeric composition for use as a consumable material in a 3D printer, the composition comprising:
a water soluble polymer comprising at least about 50 percent of a total weight of the composition;
a rheologic modifier comprising at least about 1 weight percent of the total weight of the polymeric composition; and
a filler comprising at least about 10 weight percent of the total weight of the polymeric composition;
wherein at least 90 wt % of the individual ingredient compositions before mixing are water soluble.

2. The water soluble polymeric composition of claim 1 wherein between about 95 wt % and 100 wt % of the individual ingredient compositions before mixing are water soluble.

3. The water soluble polymeric composition of claim 1 wherein 100 wt % of the composition is water soluble.

4. The water soluble polymeric composition of claim 1 wherein the water soluble polymer comprises between about 50 wt % and about 95 wt % of the total weight of the composition.

5. The water soluble polymeric composition of claim 1 wherein the water soluble polymer comprises between about 50 wt % and about 80 wt % of the total weight of the composition.

6. The water soluble polymeric composition of claim 1 wherein the rheologic modifier comprises between about 1 wt % and about 30 wt % of the total weight of the composition.

7. The water soluble polymeric composition of claim 1 wherein the rheologic modifier comprises between about 5 wt % and about 20 wt % of the total weight of the composition.

8. The water soluble polymeric composition of claim 1 wherein the filler comprises between about 10 wt % and about 50 wt % of the total weight of the composition.

9. The water soluble polymeric composition of claim 1 wherein the filler comprises between about 20 wt % and about 40 wt % of the total weight of the composition.

10. The water soluble polymeric composition of claim 1 wherein the water soluble polymer comprises semi-crystalline polyvinyl alcohol, a water soluble polyamide, a water soluble polyester or combinations thereof.

11. The water soluble polymeric composition of claim 1 wherein the rheologic modifier comprises polyethylene glycol, polypropylene glycol, poly(2-ethyl-2-oxazoline) or any combination thereof.

12. The water soluble polymeric composition of claim 1 wherein the filler comprises sodium chloride, calcium carbonate, magnesium silicate or any combination thereof.

13. A water soluble polymeric composition for use as a consumable material in a 3D printer, the composition comprising:
a water soluble polymer matrix comprising semi-crystalline polyvinyl alcohol and water soluble polyamide wherein the water soluble polymer matrix comprises at least about 50 percent of a total weight of the composition; and
a filler comprising about 10 wt % and about 50 wt % of the total weight of the composition.

14. The water soluble polymeric composition of claim 13 wherein the polymer matrix comprises:
the semi-crystalline polyvinyl alcohol in the range of between about 50 wt % and about 90 wt % of the total weight of the composition; and
the water soluble polyamide in the range of between about 10 wt % and about 30 wt % of the total weight of the composition.

15. The water soluble polymeric composition of claim 13 wherein the polymer matrix comprises:
the semi-crystalline polyvinyl alcohol in the range of between about 60 wt % and about 80 wt % of the total weight of the composition; and
the water soluble polyamide in the range of between about 15 wt % and about 25 wt % of the total weight of the composition.

16. The water soluble polymeric composition of claim 13 wherein the polymer matrix comprises:
the semi-crystalline polyvinyl alcohol in the range of between about 65 wt % and about 75 wt % of the total weight of the composition; and
the water soluble polyamide in the range of between about 17 wt % and about 23 wt % of the total weight of the composition.

17. The water soluble polymeric composition of claim 13 wherein the polymer matrix comprises:
the semi-crystalline polyvinyl alcohol in the range of between about 10 wt % and about 50 wt % of the total weight of the composition; and
the water soluble polyamide in the range of between about 40 wt % and about 85 wt % of the total weight of the composition.

18. The water soluble polymeric composition of claim 13 wherein the polymer matrix comprises:
the semi-crystalline polyvinyl alcohol in the range of between about 15 wt % and about 45 wt % of the total weight of the composition; and
the water soluble polyamide in the range of between about 50 wt % and about 80 wt % of the total weight of the composition.

19. The water soluble polymeric composition of claim 13 wherein the polymer matrix comprises:
the semi-crystalline polyvinyl alcohol in the range of between about 15 wt % and about 25 wt % of the total weight of the composition; and
the water soluble polyamide in the range of between about 50 wt % and about 75 wt % of the total weight of the composition.

20. The water soluble polymeric composition of claim 13 wherein the filler comprises between about 20 wt % and about 40 wt % of the total weight of the composition.

21. The water soluble polymeric composition of claim 13 wherein the filler comprises sodium chloride, calcium carbonate, magnesium silicate or any combination thereof.

22. The water soluble polymeric composition of claim 13 and further comprising a rheologic modifier wherein the rheologic modifier comprises between about 1 wt % and about 30 wt % of the total weight of the composition.

23. The water soluble polymeric composition of claim 13 and further comprising a rheologic modifier wherein the rheologic modifier comprises between about 5 wt % and about 20 wt % of the total weight of the composition.

24. The water soluble polymeric composition of claim 22 wherein the rheologic modifier comprises polyethylene glycol, polypropylene glycol, poly(2-ethyl-2-oxazoline) or any combination thereof.

25. A method for printing a three-dimensional part with an additive manufacturing system, the method comprising:
providing a support material comprising a water soluble polymer matrix comprising semi-crystalline polyvinyl alcohol and water soluble polyamide wherein the water soluble polymer matrix comprises at least about 50 percent of a total weight of the composition and a filler comprising about 10 wt % and about 50 wt % of the total weight of the composition, wherein the support material is disintegrable in an aqueous solution and provided in a media form suitable for the additive manufacturing system; and
processing the support material in the additive manufacturing system with a model material.

26. The method of claim 25 wherein the aqueous solution is selected from tap water and an aqueous solution with a pH between about pH 5 and about pH 9.

27. The method of claim 25 wherein the build environment of the additive manufacturing system is maintained at a temperature between ambient temperature and about 95° C.

28. The method of claim 25 wherein the polymer matrix comprises:
the semi-crystalline polyvinyl alcohol in the range of between about 60 wt % and about 80 wt % of the total weight of the composition; and
the water soluble polyamide in the range of between about 15 wt % and about 25 wt % of the total weight of the composition.

29. The method of claim 25 wherein the polymer matrix comprises:
the semi-crystalline polyvinyl alcohol in the range of between about 65 wt % and about 75 wt % of the total weight of the composition; and
the water soluble polyamide in the range of between about 17 wt % and about 23 wt % of the total weight of the composition.

30. The method of claim 25 wherein the polymer matrix comprises:
the semi-crystalline polyvinyl alcohol in the range of between about 10 wt % and about 50 wt % of the total weight of the composition; and
the water soluble polyamide in the range of between about 40 wt % and about 85 wt % of the total weight of the composition.

31. The method of claim 25 wherein the polymer matrix comprises:
the semi-crystalline polyvinyl alcohol in the range of between about 15 wt % and about 45 wt % of the total weight of the composition; and
the water soluble polyamide in the range of between about 50 wt % and about 80 wt % of the total weight of the composition.

31. The method of claim 25 wherein the polymer matrix comprises:
the semi-crystalline polyvinyl alcohol in the range of between about 15 wt % and about 25 wt % of the total weight of the composition; and
the water soluble polyamide in the range of between about 50 wt % and about 75 wt % of the total weight of the composition.

32. The method of claim 25 wherein the filler comprises between about 20 wt % and about 40 wt % of the total weight of the composition.

33. The method of claim 25 wherein the filler comprises sodium chloride, calcium carbonate, magnesium silicate or any combination thereof.

34. The method of claim 25 and wherein the polymer matrix further comprising a rheologic modifier wherein the rheologic modifier comprises between about 1 wt % and about 30 wt % of the total weight of the composition.

35. The method of claim 25 wherein the rheologic modifier comprises between about 5 wt % and about 20 wt % of the total weight of the composition.
